(19) United States
(12) Patent Application Publication
(10) Pub. No.: US 2015/0059579 A1
(43) Pub. Date: Mar. 5, 2015

(54) GAS SEPARATION MEMBRANE FOR CARBON DIOXIDE AND PREPARATION METHOD THEREOF

(71) Applicant: Gwangju Institute of Science and Technology, Gwangju (KR)

(72) Inventors: Ji-Woong PARK, Gwangju (KR); Eunkyung JEON, Gwangju (KR); Su-Young MOON, Gwangju (KR)

(73) Assignee: Gwangju Institute of Science and Technology, Gwangju (KR)

(21) Appl. No.: 14/249,866

(22) Filed: Apr. 10, 2014

(30) Foreign Application Priority Data
Aug. 28, 2013 (KR) 10-2013-0102610
Feb. 28, 2014 (KR) 10-2014-0024342

(51) Int. Cl. B01D 71/64; B01D 53/22; B01D 67/00

(52) U.S. Cl. CPC B01D 71/64; B01D 67/0083; B01D 53/228
USPC 96/14; 427/487

(57) ABSTRACT

The present disclosure relates to a gas separation membrane for filtration of carbon dioxide and a preparation method thereof. The gas separation membrane for filtration of carbon dioxide according to the present disclosure exhibits superior performance in rejecting carbon dioxide selectively from mixture gas. It is a separation membrane system leaving carbon dioxide and passing nitrogen, unlike the conventional systems which leave nitrogen and pass carbon dioxide. In addition, since compressed, highly-concentrated carbon dioxide can be obtained, the consumption of energy required for carbon dioxide storage following separation can be reduced. Furthermore, the separation membrane of the present disclosure, which is environment-friendly and consumes less energy, allows highly efficient separation and is easily applicable to the separation of carbon dioxide not only from the mixture of carbon dioxide with nitrogen but also from other mixtures of carbon dioxide with, for example, CO₂/CH₄, CO₂/H₂, etc.

### CROSS-REFERENCE TO RELATED APPLICATIONS

This application claims priority under 35 U.S.C. §119 to Korean Patent Applications Nos. 10-2013-0102610 and 10-2014-0024342, respectively filed on Aug. 28, 2013 and Feb. 28, 2014 in the Korean Intellectual Property Office, the disclosure of which is incorporated herein by reference in its entirety.

### TECHNICAL FIELD

The present disclosure relates to a gas separation membrane for carbon dioxide and a preparation method thereof.

### BACKGROUND

A conventional polymer membrane exhibits higher permeability to carbon dioxide than nitrogen or other gases because carbon dioxide has a smaller kinetic diameter than nitrogen and, in general, the solubility of carbon dioxide for a polymer membrane is higher than other gases. Therefore, many researches have been made on membranes which are more permeable to carbon dioxide. Related references include The upper bound revisited, Lloyd M. Robeson (Journal of Membrane Science, 320(2008), 390-400), High Performance Polyimide with High Intenal Free Volume Elements (Macromol. Rapid Commun., 2011, 32, 579-86), Polymer nanosieve membranes for CO₂-capture application (DOI:10.1038/NMAT2989), and so forth. However, they only describe separation membranes exhibiting high carbon dioxide permeability, and a separation membrane system which leaves carbon dioxide and passes nitrogen or other gases has not been reported.

### REFERENCES OF THE RELATED ART

### Non-Patent Documents

Non-patent document 1. The upper bound revisited, Lloyd M. Robeson (Journal of Membrane Science, 320(2008), 390-400).
Non-patent document 2. High Performance Polyimide with High Intenal Free Volume Elements (Macromol. Rapid Commun. 2011, 32, 579-86).
Non-patent document 3. Polymer nanosieve membranes for CO₂-capture application (DOI:10.1038/NMAT2989).

### SUMMARY

The present disclosure is directed to providing a gas separation membrane for filtration of carbon dioxide and a preparation method thereof.

In one general aspect, the present disclosure provides a gas separation membrane for filtration of carbon dioxide, including:

a polyimide matrix: and

a carbon dioxide adsorbing material formed by heat-treating an organic molecular network, wherein the organic molecular network is formed through polymerization and cross-linking of amino groups and isocyanate groups.

In another general aspect, the present disclosure provides a method for preparing a gas separation membrane for filtration carbon dioxide, including:

1) mixing a solution of organic molecular network with a poly(amic acid) solution;

2) coating the resulting mixture solution on a substrate and curing the poly(amic acid) to obtain a polyimide film; and

3) activating the organic molecular network through rearrangement by heat treatment.

The gas separation membrane for filtration of carbon dioxide according to the present disclosure exhibits superior performance in rejecting carbon dioxide selectively from mixture gas. Also, since the separation membrane system exhibits low permeability to carbon dioxide in comparison with other gases, compressed and highly-concentrated carbon dioxide can be obtained at high-pressure side as separation proceeds. This feature may be advantageous in that it reduces consumption of energy required for carbon dioxide storage after separation. Furthermore, high CO₂ rejection property enables removal of small amount of CO₂ impurities from valuable product gases such as hydrogen. Accordingly, the gas separation membrane according to the present disclosure can effectively separate carbon dioxide, which has a great impact on greenhouse effect and climate change, and can prevent release thereof to the atmosphere.

In addition, the gas separation membrane can be used to separate carbon dioxide not only from the mixture of carbon dioxide with nitrogen but also from other mixtures of carbon dioxide with, for example, CH₄, H₂, or He.

### BRIEF DESCRIPTION OF DRAWINGS

The above and other objects, features and advantages of the present disclosure will become apparent from the following description of certain exemplary embodiments given in conjunction with the accompanying drawings, in which:

FIG. 1 schematically shows a preparation method according to an exemplary embodiment of the present disclosure;

FIG. 2 shows permeability (a) and selectivity (b) of a gas separation membrane according to an exemplary embodiment of the present disclosure for various single gases after heat treatment at 270° C., and

FIG. 3 show FT-IR spectra of organic molecular network after heat treatment.

### DETAILED DESCRIPTION OF EMBODIMENTS

Hereinafter, exemplary embodiments will be described in detail with reference to the accompanying drawings.

The inventors of the present disclosure have made efforts to develop a gas separation membrane exhibiting superior performance in filtering carbon dioxide selectively. As a result, the inventors have developed a gas separation membrane for filtration of carbon dioxide and a preparation method thereof according to the present disclosure.

In the present disclosure, the term OMN refers to an organic molecular network, and R-OMN refers to a new network material formed by heat treatment after decomposition.

Micropores refer to pores having a pore size of 2 nm or smaller, mesopores refer to ones having a pore size greater than 2 nm and not greater than 50 nm, and macropores refer to ones having a pore size greater than 50 nm.

A conventional polymer-based gas separation membrane exhibits higher permeability to carbon dioxide than nitrogen, due to the smaller size and higher solubility of carbon dioxide than nitrogen. Therefore, carbon dioxide quickly passes through the gas separation membrane, whereas nitrogen is filtered. The gas separation membrane according to the present disclosure exhibits superior performance in passing nitrogen through the membrane but filtering carbon dioxide with decreased permeability.

Specifically, the gas separation membrane for filtration of carbon dioxide according to the present disclosure includes:

a polyimide matrix: and

a carbon dioxide adsorbing material formed by heat-treating an organic molecular network, wherein the organic molecular network is formed through polymerization and cross-linking of amino groups and isocyanate groups.

The gas separation membrane for filtration of carbon dioxide according to the present disclosure is prepared as follows. First, a solution of organic molecular network and a solution of poly(amic acid) are prepared. After the two solutions are mixed, then the resulting mixture is coated onto solid substrates, followed by evaporation to obtain dry films. The films are then heated to 200° C. to imidize poly(amic acid) to polyimide. Subsequently, the films are heated further to a temperature between 230˜350° C. to generate pores through the OMN domains via rearrangement of the urea networks. The resultant films are used as separation membranes. For a mixture gas of nitrogen and carbon dioxide, conventional polymer membrane exhibits CO₂/N₂ selectivity of 3-100, whereas the gas separation membrane according to the present disclosure exhibits a selectivity of 0.1-0.004, thus can separate carbon dioxide. The selectivity is 10-240 when expressed as N₂/CO₂ selectivity. As such, the gas separation membrane according to the present disclosure exhibits very low transportation selectivity for carbon dioxide. With such a feature, the gas separation membrane according to the present disclosure is expected to show superior carbon dioxide removal efficiency for other mixture gases such as CO₂/CH₄, CO₂/H₂, etc., as well as the mixture gas of nitrogen and carbon dioxide.

The gas separation membrane for filtration of carbon dioxide according to present disclosure may include pores having an average pore diameter of 0.2-50 nm and a specific surface area of 5-2,000 m²/g.

The organic molecular network may be formed from polymerization of a monomer represented by Chemical Formula 1 and a monomer having 2-4 isocyanate groups or from polymerization of a monomer represented by Chemical Formula 2 and a monomer having 2-4 amino groups:

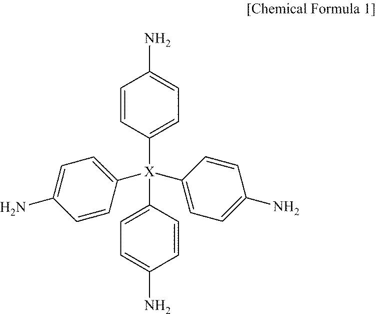

wherein X is a carbon atom or a silicon atom

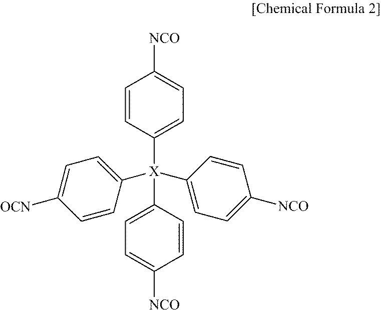

wherein X is a carbon atom or a silicon atom.

For example, the monomer having 2-4 isocyanate groups may be a C₁-C₁₀₀ aliphatic compound substituted with 2-4 isocyanate groups or a C₆-C₁₀₀ aromatic compound substituted with 2-4 isocyanate groups. Also, the monomer having 2-4 amino groups may be a C₁-C₁₀₀ aliphatic compound substituted with 2-4 amino groups or a C₆-C₁₀₀ aromatic compound substituted with 2-4 amino groups. And, for example, the C₁-C₁₀₀ aliphatic compound substituted with two isocyanate groups or the C₁-C₁₀₀ aliphatic compound substituted with two amino groups may be a compound represented by Chemical Formula 3:

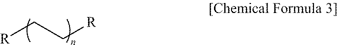

wherein R is an isocyanate group or an amino group and n is an integer from 1 to 50.

For example, the C₆-C₁₀₀ aromatic compound substituted with 2-4 isocyanate groups and/or the C₆-C₁₀₀ aromatic substituted with 2-4 amino groups may be at least one selected from a group of compounds represented by Chemical Formulas 4-10:

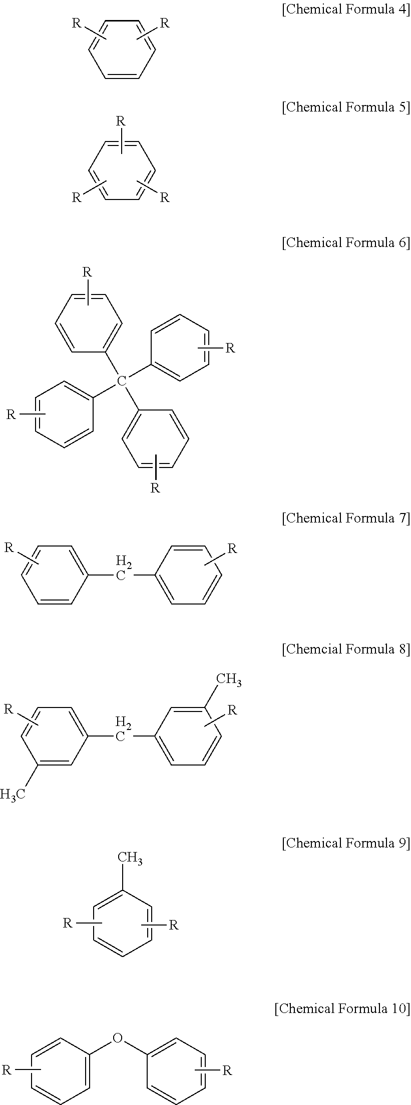

wherein R is an isocyanate group or an amino group.

The monomer having 2-4 amino groups may be, for example, tetrakis(4-aminophenyl)methane (TAPM) represented by Chemical Formula 11, p-phenylenediamine (PDA) represented by Chemical Formula 12 or 4,4′-oxydianiline (ODA) represented by Chemical Formula 13, although not being limited thereto.

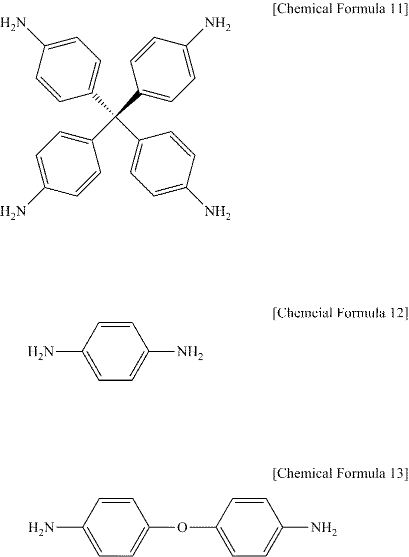

And, the monomer having 2-4 isocyanate groups may be, for example, p-phenylene diisocyanate (PDI) represented by Chemical Formula 14, hexamethylene diisocyanate (HDI) represented by Chemical Formula 15 or tetrakis(4-isocyanatophenyl)methane (TIPM) represented by Chemical Formula 16, although not being limited thereto.

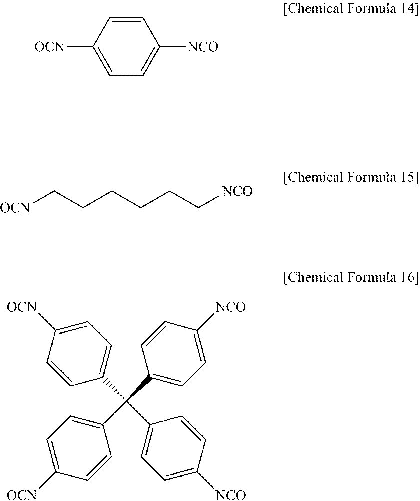

And, as a specific example, a porous polyurea structure prepared from the combination of TAPM and PDI may be represented by Chemical Formula 17.

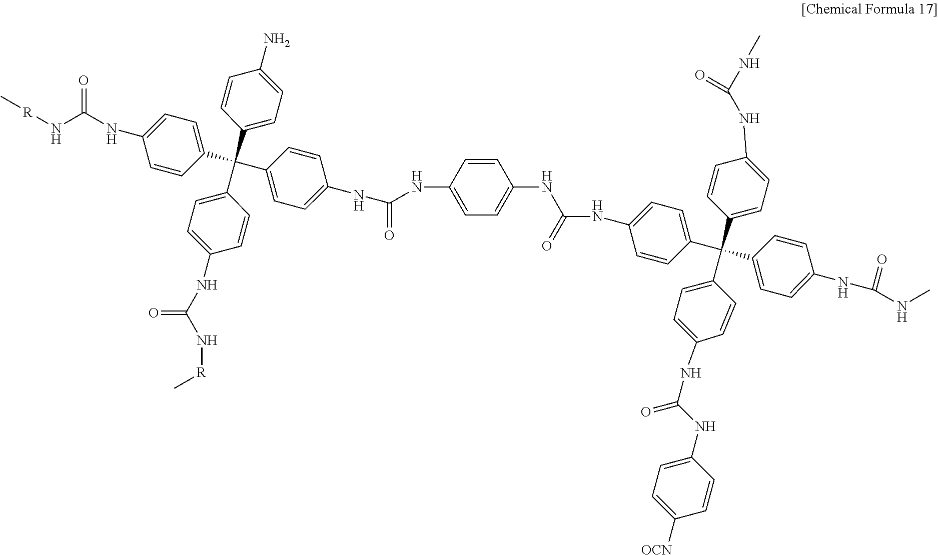

The polyimide may be formed from a reaction of a monomer having two amino groups and a monomer having two anhydride groups.

The monomer having two amino groups is not particularly limited as long as it is possible to form a polyimide by reacting with the monomer having two anhydride groups. Specifically, it may be at least one selected from the following <Compound group 1>. And, the monomer having two anhydride groups is not particularly limited as long as it is possible to form a polyimide by reacting with the monomer having two amino groups. Specifically, it may be at least one selected from the following <Compound group 2>.

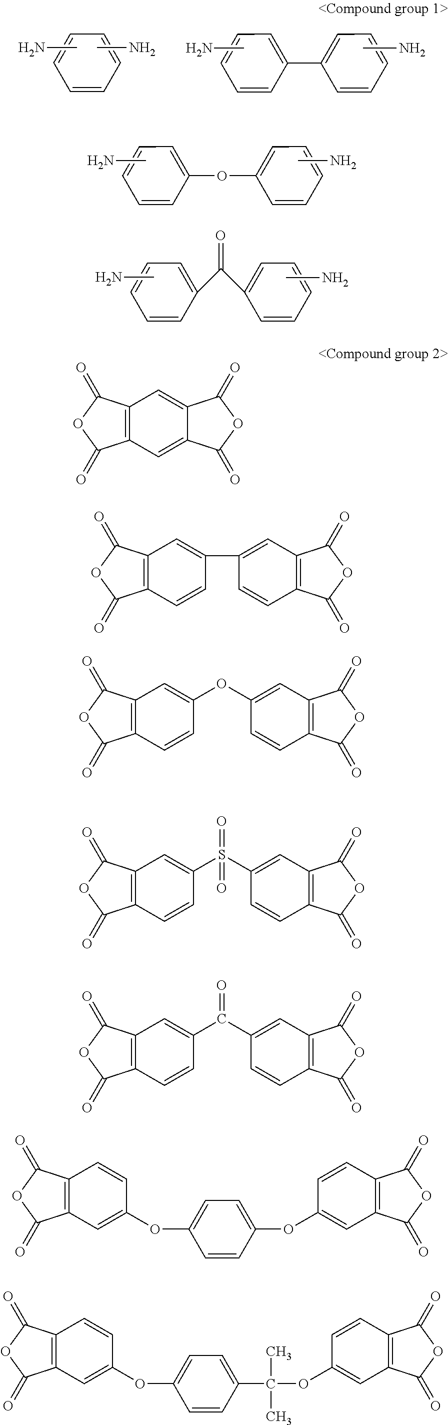

The present disclosure also provides a method for preparing a gas separation membrane for filtration of carbon dioxide, including:

1) mixing a solution of organic molecular network with a poly(amic acid) solution;

2) coating the resulting mixture solution on a substrate and curing the poly(amic acid) to obtain a polyimide film; and

3) activating the organic molecular network through rearrangement by heat treatment.

The activation of the organic molecular network through rearrangement by heat treatment in the step 3) may be achieved by dissociating urea bonds of the organic molecular network into amino groups and isocyanate groups. Subsequently, the resulting isocyanate groups may form a crosslinked network.

The organic molecular network in the step 1) may be obtained by reacting a monomer having 2-4 amino groups with a monomer having 2-4 isocyanate groups.

In the step 3), urea bonds present in the organic molecular network are dissociated into amino groups and isocyanate groups. In order to induce urea dissociation, heat treatment may be carried out at 230° C. or higher. The cleavage of the urea bond occurs following the reaction formula shown in Scheme 1:

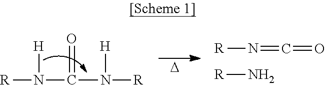

wherein R is a C₁-C₁₀₀ aliphatic or C₆-C₁₀₀ aromatic group.

As a result, a new network may be formed when the isocyanate groups, which are formed from dissociation of urea bonds, are crosslinked each other.

Specifically, the heat treatment in the step 3) may be performed at 230-300° C. If the heat treatment temperature in the step 3) is below 230° C., the urea bonds of the organic molecular network may not be dissociated and crosslinking of a new network may not occur. And, if the heat treatment temperature in the step 3) is above 300° C., the separation membrane may be damaged and physical strength may be unsatisfactory. As a result, the separation membrane may be inadequate to be used in a high-pressure membrane system.

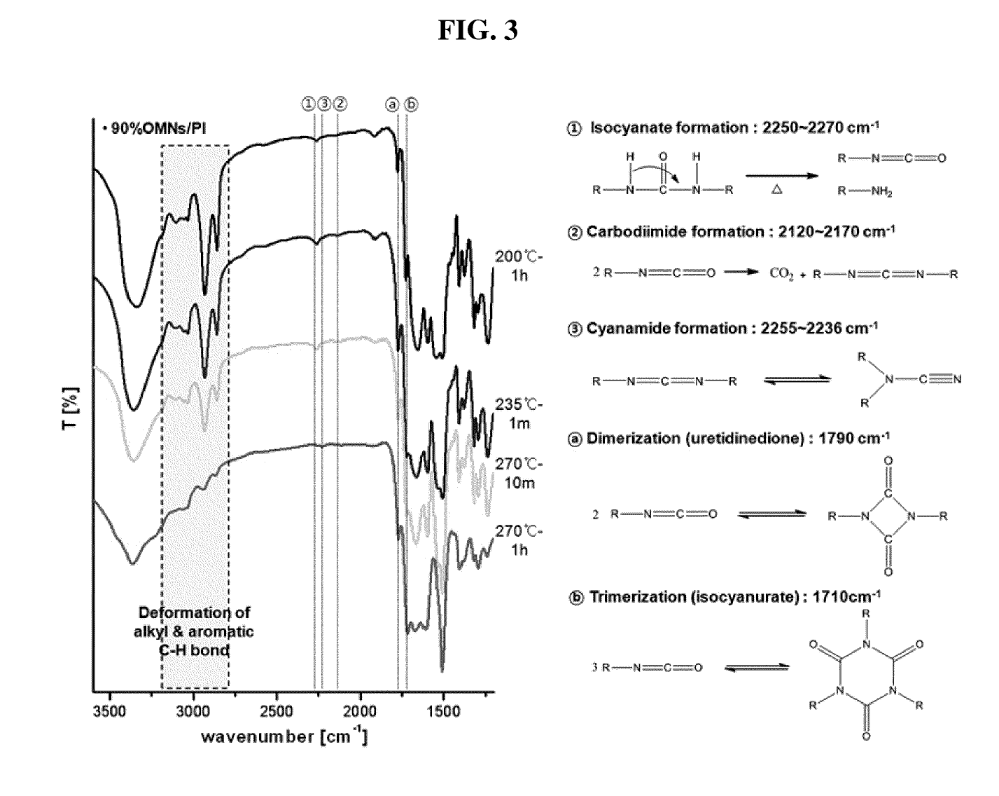

That is to say, the cleavage/dissociation of the urea bonds occurs at 230° C. or higher, and subsequent rearrangement and crosslinking occurs only below 300° C. When analyzed by IR spectroscopy, a mechanism of the cleavage/dissociation, rearrangement and crosslinking through the heat treatment is predicted as Scheme 2. A moiety containing R, which is relatively light and volatile, is removed and, as a result, the weight is decreased by 10-60%. FIG. 3 shows related data.

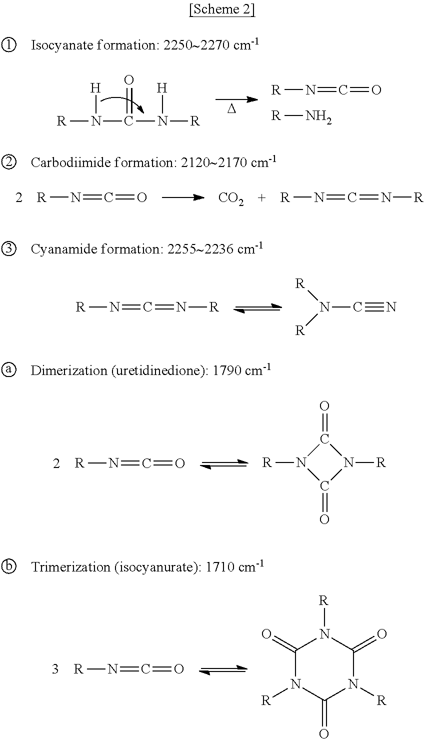

In Scheme 2, R is a C₁-C₁₀₀ aliphatic group or C₆-C₁₀₀ aromatic group.

The network formed after the heat treatment in the step 3) may include pores having an average pore diameter of 0.2-50 nm and a specific surface area of 5-2,000 m²/g.

The resulting gas separation membrane for filtration of carbon dioxide according to the present disclosure is a nanocomposite membrane including a thermally rearranged, 3-dimensional organic molecular network structure in a polyimide. As a result of the rearrangement through heat treatment, the pores of the organic molecular network in the separation membrane is activated, leading to formation of open channels in nano scale and removal of hydrogen bondings, which in turn increases the filtration amount of carbon dioxide. The gas separation membrane for filtration of carbon dioxide prepared according to the present disclosure has superior mechanical strength and can endure high pressures of 1-50 bar.

Especially, micropores, mesopores and macropores may be hierarchically formed through the heat treatment. A proper hierarchical pore structure allows easy diffusion of gas to micropores through mesopores or macropores.

Hereinafter, the present disclosure will be described in more detail through examples. However, the following examples are for illustrative purposes only and not intended to limit the scope of this disclosure.

### Example

### Synthesis of Organic Molecular Network (TAPM-HDI)

Tetrakis(4-aminophenyl)methane (MW=382.50) was dissolved in N,N-dimethylformamide (DMF) to prepare a 4 wt/vol % organic solution, and 1,4-diisocyanatohexane (MW=168.19) was dissolved in DMF to prepare a 4 wt/vol % organic solution. Subsequently, the tetrakis(4-aminophenyl)methane solution was slowly added to the 1,4-diisocyanatohexane solution and then mixed. The mixture solution was allowed to react at room temperature under nitrogen atmosphere for 72 hours.

Synthesis of Poly(Amic Acid): Precursor of Polyimide

To prepare 15 wt/vol % poly(amic acid), 4,4′-oxydianiline was added to DMAc solvent and stirred for about 30 minutes until it was completely dissolved. Subsequently, pyromellitic dianhydride was slowly added. The mixture was allowed to react at room temperature under nitrogen atmosphere for 3 hours.

Mixing and Synthesis of Nanocomposite Membrane

The 15 wt/vol % poly(amic acid) solution and the 4 wt/vol % OMN solution obtained above were mixed to prepare a mixture solution containing 10-90 wt/wt % OMN. The mixture was fully stirred, coated on a glass plate, and dried/cured at 60° C. for 2 hours, at 100° C. for 1 hour and then at 200° C. for 1 hour. As a result, a nanocomposite membrane including an organic molecular network and polyimide was synthesized.

Activation of Membrane Through Thermal Rearrangement

The prepared membrane was heated under nitrogen atmosphere at a rate of 2° C./min and kept at 230-300° C. for 1 hour. Then, the sample was allowed to cool down to room temperature. The resulting membrane was separated from the substrate by immersion in water and dried in vacuo at 100° C. for 12 hours. As a result, a gas separation membrane for filtration of carbon dioxide according to the present disclosure was prepared.

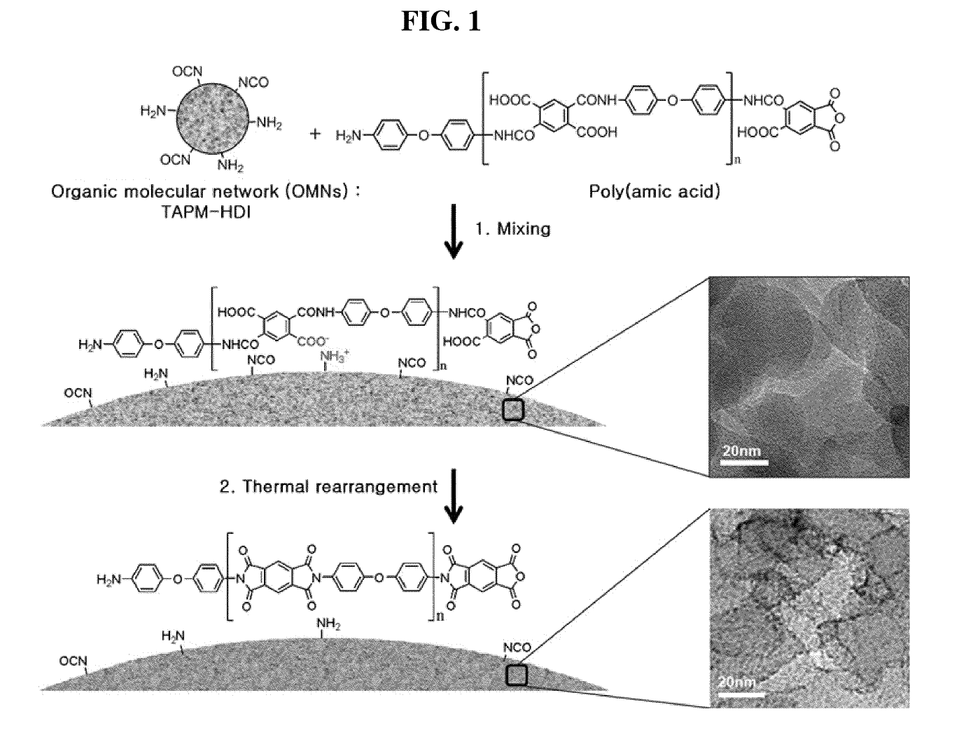

FIG. 1 schematically shows this procedure.

### Test Example

### Evaluation of Performance of Separation Membrane

Permeability to Single Gases

The permeability of the separation membrane to various gases (He (2.6 Å), CO₂ (3.3 Å) and N₂ (3.64 Å)) was measured. The measurement was made at a pressure of 0.5 bar at room temperature and the rearrangement temperature was 270° C. The amount of the gas passing through the membrane after equilibrium state was maintained (10 hours after the onset of measurement) was measured using a bubble flow meter and permeability was calculated therefrom according to the following equation.

$$P = \frac{V \cdot L}{A \cdot t \cdot Δ p} * {10}^{10} \qquad [ Equation 1 ]$$

P (Barrer): permeability

V (cm³): permeated gas volume

L (cm): membrane thickness

A (cm²): effective area of membrane

t (s): measurement time

Δp (cm Hg): pressure difference between two sides

The selectivity for single gas is represented as the ratio of permeabilities for respective gases.

$${α}_{1 / 2} = \frac{{P}_{1}}{{P}_{2}} \qquad [ Equation 2 ]$$

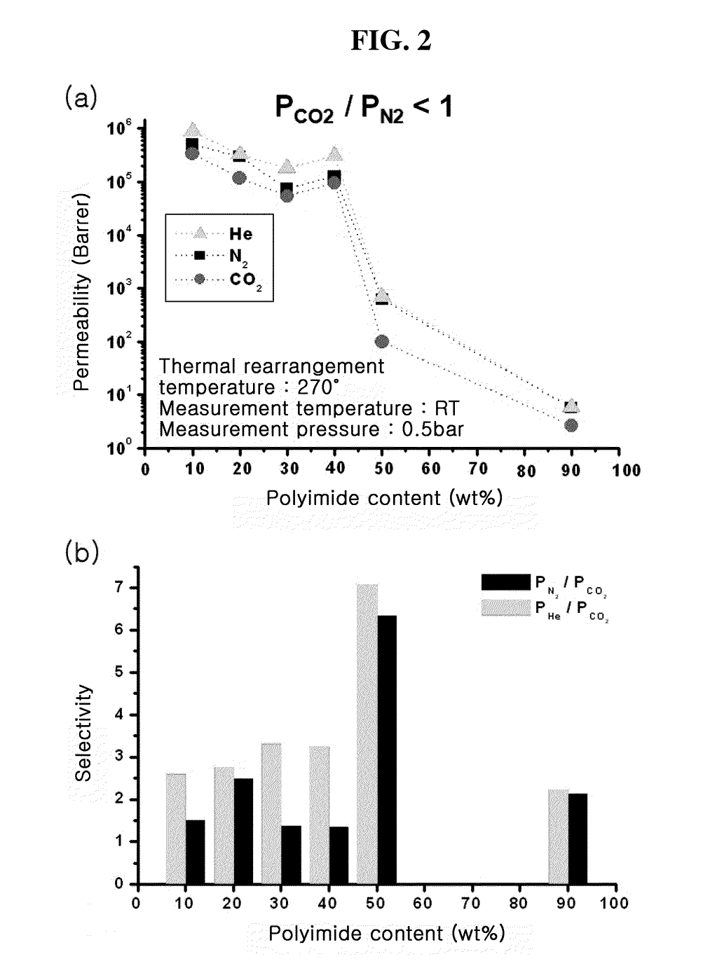

The permeability to the single gases is shown in FIG. 2. As can be seen from FIG. 2, the permeability to carbon dioxide (a) is lower than those to other gases and the selectivity for carbon dioxide (b) exhibits a reverse selectivity when compared with other separation membranes.

Permeability to Mixture Gas

In order to evaluate the ability of separating respective gases from the mixture of nitrogen and carbon dioxide, permeability and selectivity were measured for nitrogen (85)/carbon dioxide (15) mixture gas.

The measurement was made using a cross-flow membrane system at a pressure of 1 bar at room temperature, and the rearrangement temperature was 250° C. The amount of the gas passing through the membrane after equilibrium state was maintained (10 hours after the onset of measurement) was measured using a bubble flow meter and permeability was calculated.

The selectivity was measured by analyzing the gas passing through the membrane by GC. Helium gas flowing at a rate of 5 mL/min was used as a carrier gas. The selectivity was calculated according to the following equation.

$${α}_{1 / 2} = \frac{[ {X}_{1} / {X}_{2} ] permeate}{[ {X}_{1} / {X}_{2} ] feed} \qquad [ Equation 3 ]$$

The result is shown in Table 1.

As can be seen from Table 1, the membrane shows remarkably higher selectivity for carbon dioxide as compared to other gases.

TABLE 1

| | | feed | | permeate | | |
|---|---|---|---|---|---|---|
| | | composition | | composition | | |
| wt % | | (mol %) | | (mol %) | | separation |
| OMNs | TR | N₂ | CO₂ | N₂ | CO₂ | factor |
| 60 | 200 | 80.7 | 19.3 | 94.9 | 5.1 | 4.5 |
| | 230 | | | 96.6 | 3..4 | 6.8 |
| | 240 | | | 95.6 | 4.4 | 5.2 |
| | 250_1st | | | 99 | 1 | 23.7 |
| | 250_2nd | | | 98.5 | 1.5 | 15.7 |
| | 255 | | | 94.5 | 5.5 | 4.1 |
| | 260_1st | | | 94.4 | 5.6 | 4.0 |
| | 260_2nd | | | 97.5 | 2.5 | 9.3 |
| | 270 | | | 81.4 | 18.6 | 1.05 |

To conclude, the gas separation membrane for filtration of carbon dioxide according to the present disclosure exhibits very superior ability of separating carbon dioxide by lowering its permeability, unlike the existing gas separation membranes which easily pass carbon dioxide.

While the present disclosure has been described with respect to the specific embodiments, it will be apparent to those skilled in the art that various changes and modifications may be made without departing from the spirit and scope of the disclosure as defined in the following claims.

1. A gas separation membrane for filtration of carbon dioxide, including:
a polyimide matrix: and
a carbon dioxide adsorbing material formed by heat-treating an organic molecular network, wherein the organic molecular network is formed through polymerization and cross-linking of amino groups and isocyanate groups.

2. The gas separation membrane for filtration of carbon dioxide according to claim 1, wherein the network material is formed as the organic molecular network is dissociated into amino groups and isocyanate groups by heat treatment and at the same time the isocyanate groups are crosslinked, wherein the isocyanate groups are formed as urea bonds of the organic molecular network are dissociated by heat treatment.

3. The gas separation membrane for filtration of carbon dioxide according to claim 2, wherein the dissociation by heat treatment occurs following a mechanism according to Scheme 1: 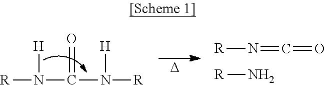
wherein R is a C₁-C₁₀₀ aliphatic or C₆-C₁₀₀ aromatic group.

4. The gas separation membrane for filtration of carbon dioxide according to claim 2, wherein the crosslinking of the isocyanate groups occurs following a mechanism according to Scheme 2: 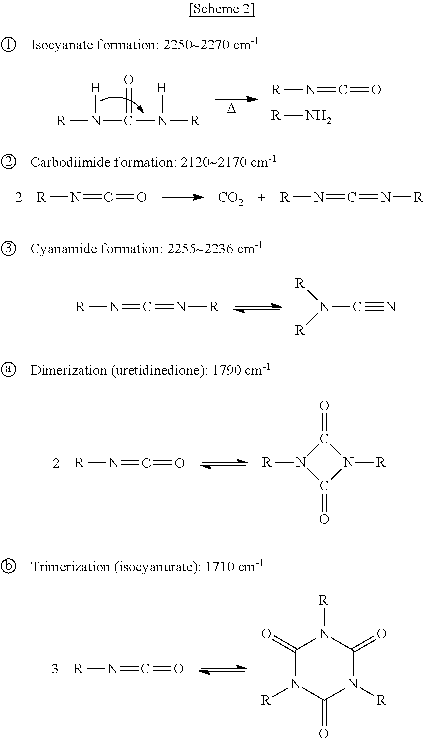
wherein R is a C₁-C₁₀₀ aliphatic or C₆-C₁₀₀ aromatic group.

5. The gas separation membrane for filtration of carbon dioxide according to claim 1, wherein said heat treatment is performed at 230-300° C.

6. The gas separation membrane for filtration of carbon dioxide according to claim 1 comprising micropores having an average pore diameter of 0.2-50 nm and a specific surface area of 50-2,000 m²/g.

7. The gas separation membrane for filtration of carbon dioxide according to claim 1, wherein the polyimide is formed from a reaction of a monomer having two amino groups and a monomer having two anhydride groups.

8. The gas separation membrane for filtration of carbon dioxide according to claim 7, wherein the monomer having two amino groups is at least one selected from a <Compound group 1> and the monomer having two anhydride groups is at least one selected from a <Compound group 2>:

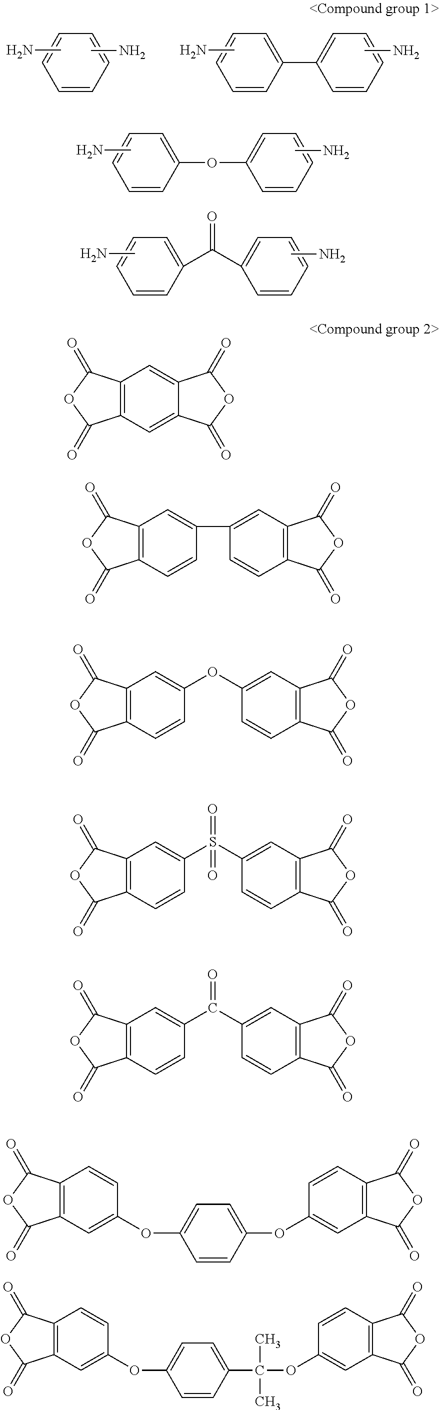

9. The gas separation membrane for filtration of carbon dioxide according to claim 1, wherein the organic molecular network is formed from polymerization of a monomer represented by Chemical Formula 1 and a monomer having 2-4 isocyanate groups, or from polymerization of a monomer represented by Chemical Formula 2 and a monomer having 2-4 amino groups: 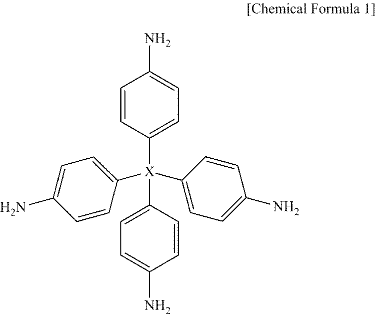
wherein X is a carbon atom or a silicon atom 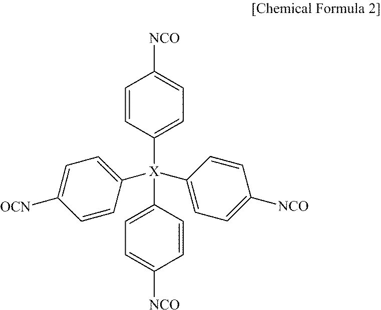
wherein X is a carbon atom or a silicon atom.

10. The gas separation membrane for filtration of carbon dioxide according to claim 9, wherein the monomer having 2-4 isocyanate groups is a C₁-C₁₀₀ aliphatic compound substituted with 2-4 isocyanate groups or a C₆-C₁₀₀ aromatic compound substituted with 2-4 isocyanate groups, and the monomer having 2-4 amino groups is a C₁-C₁₀₀ aliphatic compound substituted with 2-4 amino groups or a C₆-C₁₀₀ aromatic compound substituted with 2-4 amino groups.

11. The gas separation membrane for filtration of carbon dioxide according to claim 10, wherein the C₁-C₁₀₀ aliphatic compound substituted with two isocyanate groups or the C₁-C₁₀₀ aliphatic compound substituted with two amino groups is a compound represented by Chemical Formula 3: 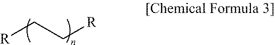
wherein R is an isocyanate group or an amino group and n is an integer from 1 to 50, and
the C₆-C₁₀₀ aromatic compound substituted with 2-4 isocyanate groups and the C₆-C₁₀₀ aromatic compound substituted with 2-4 amino groups is at least one selected from a group of compounds represented by Chemical Formulas 4-10: 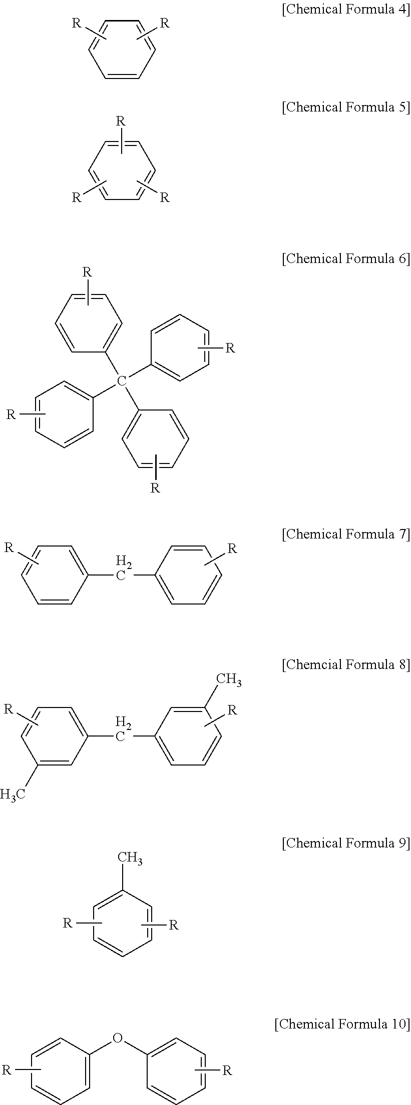
wherein R is an isocyanate group or an amino group.

12. A method for preparing a gas separation membrane for filtration carbon dioxide, including:
1) mixing a solution of organic molecular network with a poly(amic acid) solution;
2) coating the resulting mixture solution on a substrate and curing the poly(amic acid) to obtain a polyimide film; and
3) activating the organic molecular network through rearrangement by heat treatment.

13. The method for preparing a gas separation membrane for filtration of carbon dioxide according to claim 12, wherein the organic molecular network is formed by reacting a monomer having 2-4 amino groups with a monomer having 2-4 isocyanate groups.

14. The method for preparing a gas separation membrane for filtration of carbon dioxide according to claim 12, wherein the heat treatment is performed at 230-300° C.

15. The method for preparing a gas separation membrane for filtration of carbon dioxide according to claim 12, wherein the activation of the organic molecular network material is achieved as urea bonds of the organic molecular network are dissociated into amino groups and isocyanate groups by heat treatment and at the same time the isocyanate groups form a crosslinked network.

16. The method for preparing a gas separation membrane for filtration of carbon dioxide according to claim 15, wherein the network formed after the heat treatment comprises micropores having an average pore diameter of 0.2-50 nm and a specific surface area of 50-2,000 m²/g.

17. The method for preparing a gas separation membrane for filtration of carbon dioxide according to claim 15, wherein said dissociation of the urea bond occurs following a mechanism according to Scheme 1: 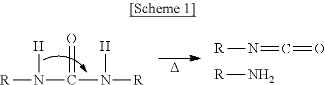
wherein R is a C₁-C₁₀₀ aliphatic or C₆-C₁₀₀ aromatic group.

18. The method for preparing a gas separation membrane for filtration of carbon dioxide according to claim 15, wherein said crosslinking of the isocyanate groups is achieved through rearrangement following a mechanism according to Scheme 2: 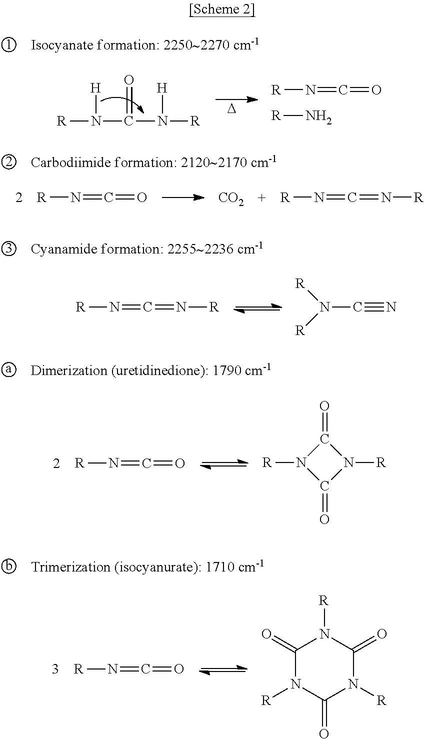
wherein R is a C₁-C₁₀₀ aliphatic or C₆-C₁₀₀ aromatic group.

19. A gas injection apparatus comprising the gas separation membrane for filtration of carbon dioxide according to claim 1.
